(19) United States
(12) Patent Application Publication
(10) Pub. No.: US 2009/0210629 A1
(43) Pub. Date: Aug. 20, 2009

(54) METHOD, SYSTEM AND COMPUTER PROGRAM PRODUCT FOR SELECTIVELY PURGING CACHE ENTRIES

(75) Inventors: Michael A. Blake, Wappingers Falls, NY (US); Christine C. Jones, Poughkeepsie, NY (US); Pak-kin Mak, Poughkeepsie, NY (US); Arthur J. O'Neill, JR., Wappingers Falls, NY (US)

Correspondence Address: CANTOR COLBURN LLP-IBM POUGHKEEPSIE, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/032,058

(22) Filed: Feb. 15, 2008

(51) Int. Cl. G06F 12/08

(52) U.S. Cl. 711/135; 711/E12.022

(57) ABSTRACT

A method, system and computer program product for selectively purging entries in a cache of a computer system. The method includes determining a starting storage address and a length of the storage address range to be purged, determining preset values for a congruence class and a compartment of a cache directory, accessing the cache directory based on the preset value of the congruence class, and selecting an entry in the cache directory based on the preset value of the compartment, determining validity of the entry accessed by examining an ownership tag of the entry, comparing a line address of the entry with the starting storage address and a sum of the starting storage address and the length of the storage address range, and selectively purging the entry based on the comparison result.

### BACKGROUND OF THE INVENTION

This invention relates generally to a method for purging cache entries in a computer system, and more particularly to providing a method, system and computer program product for selectively purging cache entries thereby reducing the number of cache directory accesses, and decreasing the amount of time required to perform purging of the cache entries.

When multiple images are stored in computer systems, it is highly desirable to dynamically reallocate storage among the multiple images in order to increase storage sizes for images which need improved throughput. Therefore, it is necessary to purge cache entries which correspond to respective storage addresses being reallocated from existing images and into critical images. Typically, the storage addresses being reallocated include a large contiguous range of storage addresses. The purging of cache entries containing storage address being reallocated is required to be performed quickly to minimize any impact on the system performance. FIG. I illustrates a conventional cache directory 10 which is organized into Y congruence classes (ranging from 0 to Y−1) and X compartments (ranging from 0 to X−1). The total number of directory entries is equal to Y multiplied by X, where there is one entry for each line of data in the cache. FIG. 2 illustrates a mapping of a storage address 100 to a directory entry 110. As shown, a subset of the storage address bits are used to specify which Y congruence class to access while the remaining (address index) address bits are included as part of the directory entry 110. Each directory entry 110 also includes an ownership tag which indicates the ownership state of the line.

In a conventional method, purging of storage addresses 100 from a wide storage range is performed by separate cache directory lookups for each address within the storage range in order to determine whether any of the storage addresses from the storage being reallocated exists within the cache. If the address does exist in the cache, then an additional step is required to purge the data from the cache. Using this method, the number of directory lookups required to be performed is equal to the number of addresses within the targeted storage range being reallocated. If the size of the storage being reallocated is many times greater than the size of the cache, the number of directory lookups required is proportional to the size difference and thus, increases the amount of time required to complete the purging of addresses belonging to the storage being reallocated.

It would be desirable to be able to reduce the number of directory accesses required when purging cache entries.

### BRIEF SUMMARY OF THE INVENTION

An exemplary embodiment includes a method for selectively purging entries in a cache of a computer system. The method includes determining a starting storage address and a length of the storage address range to be purged, determining preset values for a congruence class and a compartment of a cache directory, accessing the cache directory based on the preset value of the congruence class, and selecting an entry in the cache directory based on the preset value of the compartment, determining validity of the entry accessed by examining an ownership tag of the entry, comparing a line address of the entry with the starting storage address and a sum of the starting storage address and the length of the storage address range, and selectively purging the entry based on the comparison result.

Another exemplary embodiment includes a system having a processor, a system memory, a bus system and a cache. The system includes a purge engine logic unit coupled with a cache directory having a plurality of entries including a plurality of congruence classes and compartments. The purge engine logic unit includes a congruence class incrementer which increments a value of the congruence class, a compartment incrementer which increments a value of the compartment, and a directory compartment selector which selects a compartment of the cache directory. When the system determines to purge entries in the cache directory, a starting storage address and a length of the storage address range to be purged are loaded into the purge engine logic unit, the purge engine logic unit sets preset values for the congruence class and the compartment, accesses the cache directory based on the preset value of the congruence class, and selects an entry in the cache directory based on the preset value of the compartment selected by the directory compartment selector, determines validity of the entry by examining an ownership tag of the entry, compares a line address of the entry with the starting storage address and a sum of the starting storage address and the length of the storage address range, and selectively purges the entry based on the comparison result.

A further exemplary embodiment includes a computer program product corresponding to the above-summarized method.

### BRIEF DESCRIPTION OF THE DRAWINGS

Referring now to the drawings wherein like elements are numbered alike in the several FIGURES:

FIG. 1 illustrates a conventional cache directory.

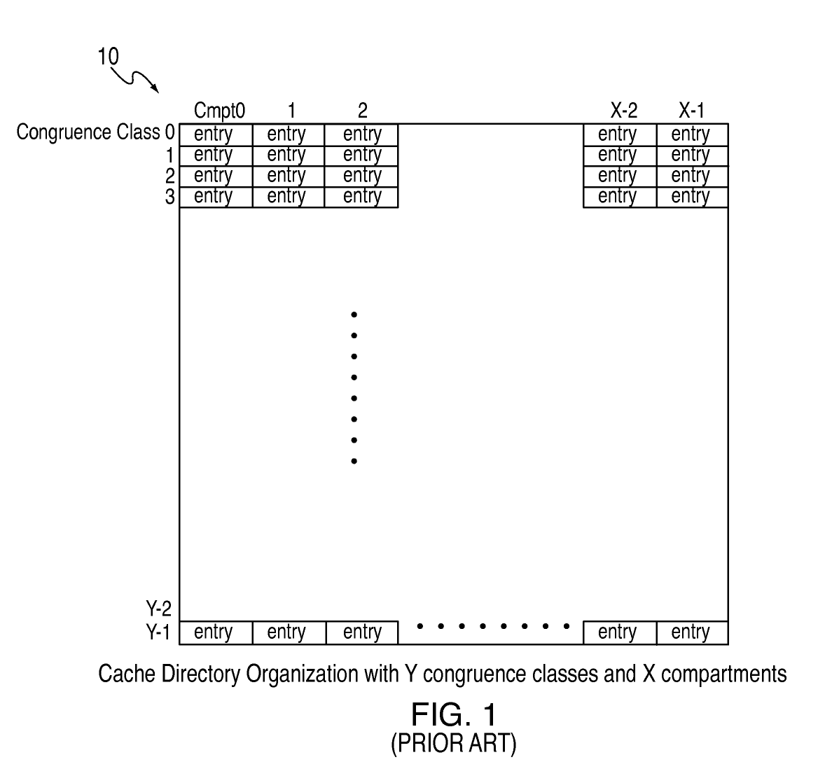

FIG. 2 illustrates a mapping of a conventional storage address to a directory entry.

FIG. 3 illustrates a flowchart of a method for selectively purging cache entries that can be implemented within embodiments of the present invention.

FIG. 4 illustrates hardware components of a purge engine logic unit that can be implemented within embodiments of the present invention.

### DETAILED DESCRIPTION OF EXEMPLARY EMBODIMENTS

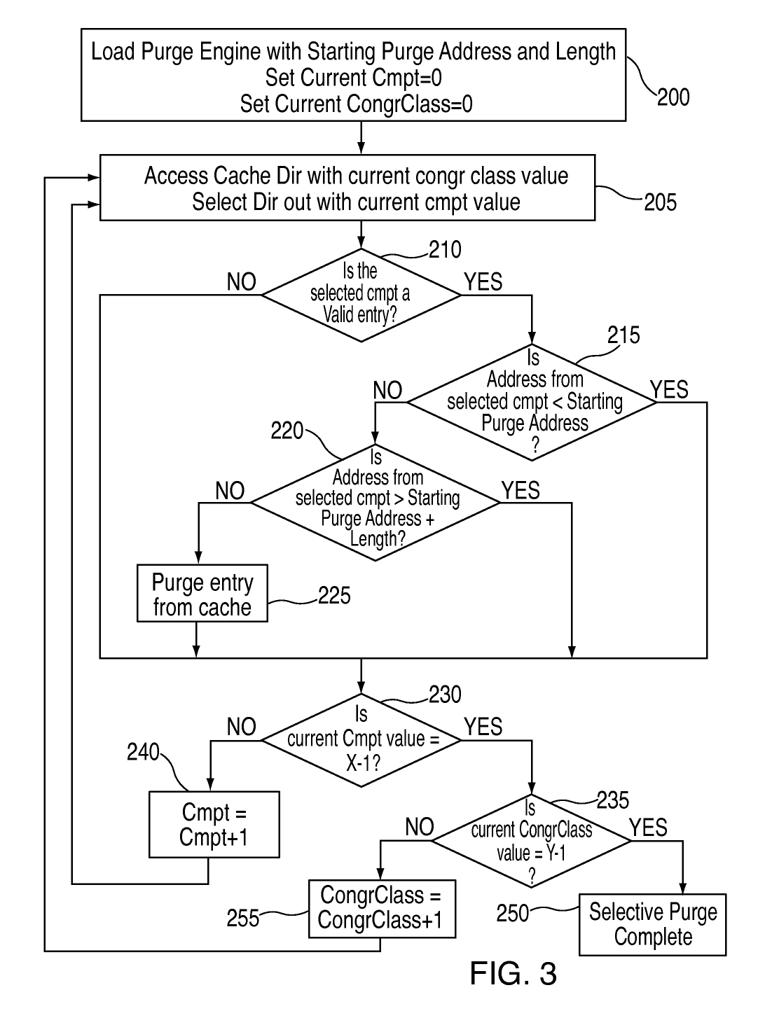

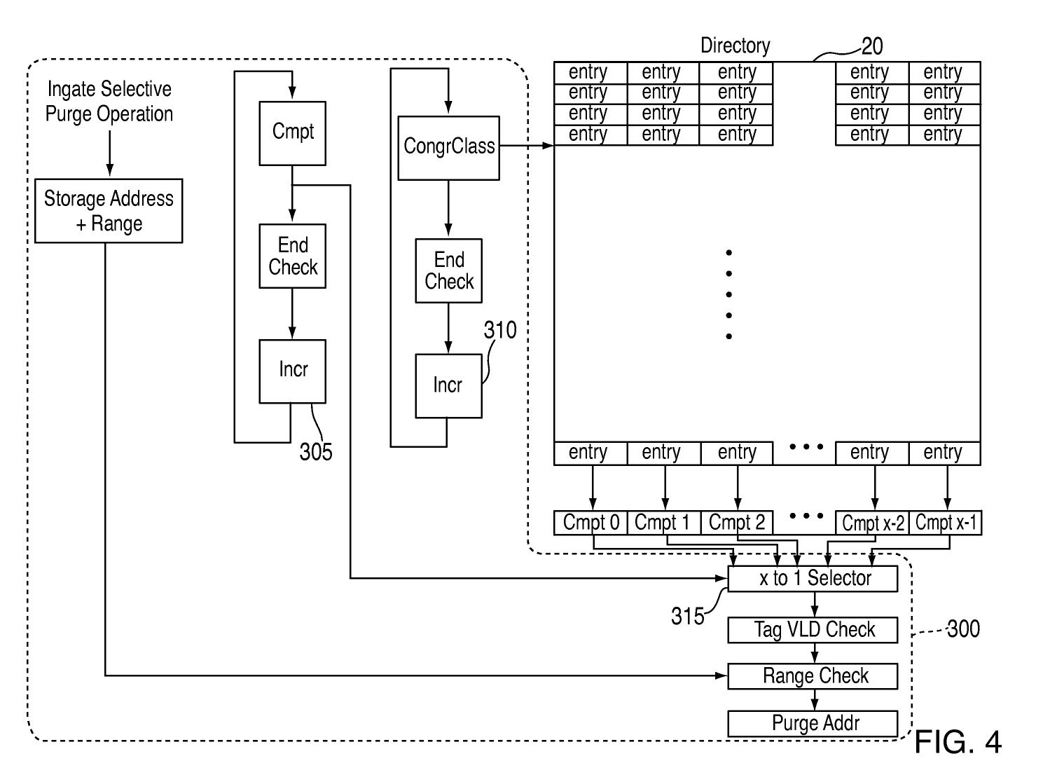

Turning now to the drawings in greater detail, it will be seen that in FIG. 3 there is a flowchart of a method for selectively purging cache entries that can be implemented within embodiments of the present invention. The flowchart of FIG. 3, illustrates steps taken to implement an exemplary embodiment of the present invention with reference to the purge engine logic unit 300 shown in FIG. 4. The purge engine logic unit 300 functions as follows:

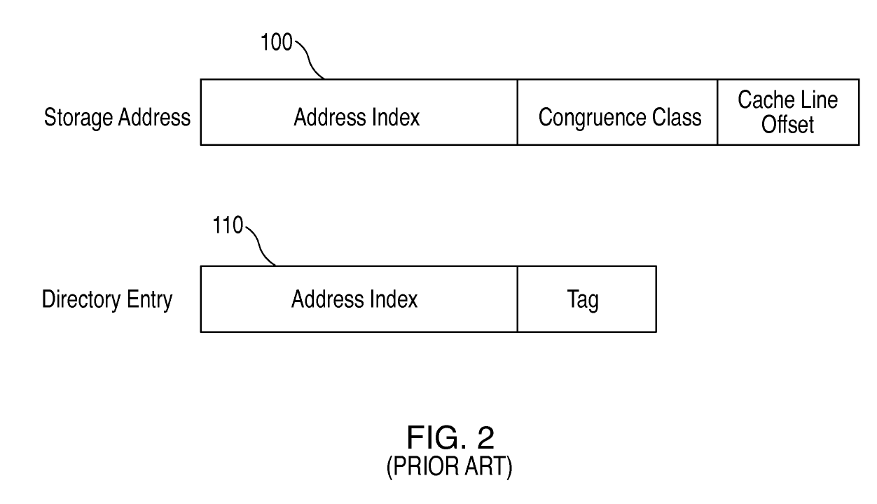

In FIG. 3, in operation 200, a starting storage address and a length of the storage address range to be purged is determined and loaded into the purge engine logic unit 300 (see FIG. 4). Further, preset values for a congruence class and a compartment of a cache directory 20 are determined. According to an exemplary embodiment, the initial preset values for the congruence class and the compartment are both set at 0. From operation 200, the process moves to operation 205 where the cache directory 20 is accessed based on the preset value of the congruence class, and an entry in the cache directory 20 is selected based on the preset value of the compartment. When the entry is selected in operation 205, the process moves to operation 210, where the validity of the selected entry is determined by examining an ownership tag (see FIG. 2, for example) of the entry. When it is determined that the entry is valid in operation 210, the process performs comparisons of a line address of the entry with the starting storage address and a sum of the starting storage address and the length of the storage address range (see operations 215 and 220). According to an exemplary embodiment, the line address associated with this entry is created by appending the congruence class address bits with the address index address bits obtained from this entry as shown in FIG. 2, for example.

That is, from operation 210, the process moves to operation 215, where a line address of the entry is compared with the starting storage address. Alternatively, when it is determined that the selected entry is invalid in operation 210, the process moves to operation 230, where it is determined whether the current compartment value is equal to a maximum value.

According to an exemplary embodiment, when it is determined that the line address is less than the starting purge address in operation 215, the process moves to operation 230, where it is determined whether the current compartment value is equal to a maximum value (X−1). When it is determined that the current compartment is less than the maximum value (X−1), the compartment is incremented via a compartment incrementer 305 (see FIG. 4) and the process returns to operation 205 where an entry is now accessed based upon the current compartment value as incremented and the congruence class value and the operations 205 through 240 are repeated until the current compartment value is equal to the maximum value (X−1).

Alternatively, according to an exemplary embodiment, when it is determined that the line address is greater than the starting purge address in operation 215, the process moves to operation 220, where the line address is compared with a sum of the starting storage address and the length of the storage address range. When it is determined that the line address is greater than the sum in operation 220, the process moves to operation 230, where it is determined whether the current compartment value is equal to a maximum value (X−1). As mentioned above, when it is determined that the current compartment value is less than the maximum value (X−1), the current compartment value is incremented by one and the process returns to operation 205 and repeats operations 205 through 230 until the current compartment value is equal to the maximum value (X−1).

According to an exemplary embodiment, when it is determined that the line address is less than the sum in operation 220, the process moves to operation 225, where the entry is selectively purged from the cache directory 20 based on the comparison result and from operation 225, the process moves to operation 230, where it is determined whether the current compartment value is equal to a maximum value (X−1).

Referring to operation 230, when it is determined that the current compartment value is equal to the maximum value (X−1), the process moves to operation 235, where it is determined whether the current congruence class value is equal to a maximum value (Y−1). When it is determined that the current class value is equal to the maximum value (Y−1) in operation 235, the process moves to operation 250 where the selective purging of entries in the cache directory 20 is completed. Alternatively, when it is determined that the current congruence class value is less than the maximum value (Y−1), the current congruence class value is incremented by one via a congruence class incrementer 310 (see FIG. 4) and the process returns and repeats operations 205 through 255, as necessary, until the congruence class value is equal to the maximum value (Y−1). Once it is determined that the congruence class value is equal to the maximum value, then as mentioned above, the process moves to operation 250 where the selective purging of entries in the cache directory 20 is completed.

As shown in FIG. 4, the purge engine logic unit 300 comprises the following components: the compartment incrementer 305, the congruence class incrementer 310, and a directory compartment selector 315 which selects a compartment corresponding to an entry of the cache directory 20. When the system determines to purge entries in the cache directory 20, as mentioned above, a starting storage address and a length of the storage address range to be purged are loaded into the purge engine logic unit 300, the purge engine logic unit sets preset values for the congruence class and the compartment, accesses an entry in the cache directory 20 based on the preset values, accesses the cache directory 20 based on the preset value of the congruence class, and selects an entry in the cache directory 20 based on the preset value of the compartment selected by the directory compartment selector 315 and determines the validity of the entry accessed by examining an ownership tag of the entry via a Tag Validity Check. The purge engine logic unit 300 then compares a line address of the entry with the starting storage address and a sum of the starting storage address and the length of the storage address range via a Range Check, and selectively purges the entry based on the comparison result. As shown in FIGS. 3 and 4, the compartment incrementer 305 and the congruence class incrementer 310 respectively increment the compartment value and the congruence class value until these values reach a maximum value, and end check is repeatedly performed in both operations 230 and 235 respectively via an End Check as shown in FIG. 4, prior to incrementing the values.

According to an exemplary embodiment, the entry is purged when it is determined that the line address is greater than the starting storage address and less than a sum of the starting storage address and the length of the storage address range.

Further, when it is determined that the line address is not a valid entry, when it is determined that the line address is less than the starting storage address, when it is determined that the line address is greater than the sum of the starting storage address entry and the length of the storage address range or after the purging of the entry has been completed, the compartment incrementer 305 increments the preset value of the compartment by one when it is determined that the preset value is less than the maximum value and continuously repeats the accessing, determining, comparing, selectively purging of entries, and incrementing of the preset value of the compartment until the preset value of the compartment equals the maximum value (X−1). Then, upon reaching the maximum value (X−1) of the compartment, it is determined whether the preset value of the congruence class equals a maximum value (Y−1) and when the preset value of the congruence class is less than the maximum value (Y−1), the congruence class incrementer 310 increments the preset value of the congruence class and continuously repeats the accessing, determining, comparing, selectively purging of entries and incrementing of the present value of the congruence class until the preset value of the congruence class is equal to the maximum value (Y−1).

According to an exemplary embodiment, the number of directory accesses required to complete all the necessary purges is equal to the number of directory entries, i.e. Y congruence classes multiplied by X compartments, independent of the number of lines in the specified address range.

Technical effects and benefits include reducing the number of directory accesses to a number that is independent of the address range size being purged, thereby reducing the amount of time required to perform the cache purges. The number of directory accesses required is equal to the number of directory entries regardless of the number of addresses from the storage range being reallocated. This is accomplished thru a series of “reverse” directory lookups and compares.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A method for selectively purging entries in a cache of a computer system, the method comprising:
determining a starting storage address and a length of the storage address range to be purged;
determining preset values for a congruence class and a compartment of a cache directory;
accessing the cache directory based on the preset value of the congruence class, and selecting an entry in the cache directory based on the preset value of the compartment;
determining validity of the entry by examining an ownership tag of the entry;
comparing a line address of the entry with the starting storage address and a sum of the starting storage address and the length of the storage address range; and
selectively purging the entry based on the comparison result.

2. The method of claim 1, wherein selectively purging the entry comprises:
purging the entry when it is determined that the line address is greater than the starting storage address and less than a sum of the starting storage address and the length of the storage address range.

3. The method of claim 1, further comprises:
determining whether the preset value of the compartment equals a maximum value, when it is determined that the line address is not a valid entry, when it is determined that the line address is less than the starting storage address, when it is determined that the line address is greater than the sum of the starting storage address entry and the length of the storage address range or after the purging of the entry has been completed;
incrementing the preset value of the compartment by one when it is determined that the preset value of the compartment is less than the maximum value and repeating the accessing, determining, comparing, selectively purging of entries and incrementing of the preset value until the preset value of the compartment equals the maximum value;
determining whether the preset value of the congruence class equals a maximum value, when it is determined that the preset value of the compartment is equal to the maximum value; and
incrementing the preset value of the congruence class when it is determined that the preset value of the congruence class is less than the maximum value and repeating the accessing, determining, comparing, selectively purging of entries and incrementing of the preset value of the congruence class until the preset value of the congruence class is equal to the maximum value.

4. The method of claim 3, wherein a total number of times the cache directory is accessed is equal to the number of entries of the cache directory.

5. The method of claim 1, wherein initial preset values of the congruence class and the compartment are equal to 0.

6. The method of claim 1, wherein a subset of storage address bits in the storage address are used to specify which congruence class to access, while remaining address bits are included in the entry.

7. The method of claim 6, wherein the line address is created by appending the storage address bits in the of the congruence class with the address bits included in the entry.

8. A computer program product comprising a computer useable medium including a computer readable program, wherein the computer readable program when executed on a computer causes the computer to implement a method for selectively purging entries in a cache of a computer system, the method comprising:
determining a starting storage address and a length of the storage address range to be purged;
determining preset values for a congruence class and a compartment of a cache directory;
accessing the cache directory based on the preset value of the congruence class, and selecting an entry in the cache directory based on the preset value of the compartment;
determining validity of the entry by examining an ownership tag of the entry;
comparing a line address of the entry with the starting storage address and a sum of the starting storage address and the length of the storage address range; and
selectively purging the entry based on the comparison result.

9. The computer program product of claim 8, wherein selectively purging the entry comprises:
purging the entry when it is determined that the line address is greater than the starting storage address and less than a sum of the starting storage address and the length of the storage address range.

10. The computer program product of claim 8, further comprising:
determining whether the preset value of the compartment equals a maximum value, when it is determined that the line address is not a valid entry, when it is determined that the line address is less than the starting storage address, when it is determined that the line address is greater than the sum of the starting storage address entry and the length of the storage address range or after the purging of the entry has been completed;
incrementing the preset value of the compartment by one when it is determined that the preset value of the compartment is less than the maximum value and repeating the accessing, determining, comparing, selectively purging of entries and incrementing of the preset value until the preset value of the compartment equals the maximum value;
determining whether the preset value of the congruence class equals a maximum value, when it is determined that the preset value of the compartment is equal to the maximum value; and
incrementing the preset value of the congruence class when it is determined that the preset value of the congruence class is less than the maximum value and repeating the accessing, determining, comparing, selectively purging of entries and incrementing of the preset value of the congruence class until the preset value of the congruence class is equal to the maximum value.

11. The computer program product of claim 10, wherein a total number of times the cache directory is accessed is equal to the number of entries of the cache directory.

12. The computer program product of claim 8, wherein initial preset values of the congruence class and the compartment are equal to 0.

13. The computer program product of claim 8, wherein a subset of storage address bits in the storage address are used to specify which congruence class to access, while remaining address bits are included in the entry.

14. A system having a processor, a system memory, a bus system and a cache, the system comprising:
a purge engine logic unit connected with a cache directory having a plurality of entries including a plurality of congruence classes and compartments, the purge engine logic unit comprising:
a congruence class incrementer which increments a value of the congruence class;
a compartment incrementer which increments a value of the compartment; and
a directory compartment selector which selects a compartment of the cache directory;
wherein when the system determines to purge entries in the cache directory, a starting storage address and a length of the storage address range to be purged are loaded into the purge engine logic unit, the purge engine logic unit sets preset values for the congruence class and the compartment, accesses the cache directory based on the preset value of the congruence class, and selects an entry in the cache directory based on the preset value of the compartment selected by the directory compartment selector, determines validity of the entry by examining an ownership tag of the entry, compares a line address of the entry with the starting storage address and a sum of the starting storage address and the length of the storage address range, and selectively purges the entry based on the comparison result.

15. The system of claim 14, wherein the entry is purged when it is determined that the line address is greater than the starting storage address and less than a sum of the starting storage address and the length of the storage address range.

16. The system of claim 14, wherein when it is determined that the line address is not a valid entry, when it is determined that the line address is less than the starting storage address, when it is determined that the line address is greater than the sum of the starting storage address entry and the length of the storage address range or after the purging of the entry has been completed, the compartment incrementer increments the preset value of the compartment by one when it is determined that the preset value is less than the maximum value and continuously repeats the accessing, determining, comparing, selectively purging of entries, and incrementing of the preset value of the compartment until the preset value of the compartment equals the maximum value.

17. The system of claim 16, wherein upon reaching the maximum value of the compartment, it is determined whether the preset value of the congruence class equals a maximum value and when the preset value of the congruence class is less than the maximum value, the congruence class incrementer increments the preset value of the congruence class and continuously repeats the accessing, determining, comparing, selectively purging of entries and incrementing of the present value of the congruence class until the preset value of the congruence class is equal to the maximum value.

19. The system of claim 16, wherein a total number of times the cache directory is accessed is equal to the number of entries of the cache directory.

20. The system of claim 14, wherein initial preset values of the congruence class and the compartment are equal to 0.
